(19) United States
(12) Patent Application Publication
(10) Pub. No.: US 2026/0084210 A1
(43) Pub. Date: Mar. 26, 2026

(54) PYROPHORIC METALS AND METAL ALLOYS

(71) Applicant: Coogee Titanium Pty Ltd, Kwinana, Western Australia (AU)

(72) Inventors: Michael Bradley Berven, Kwinana, Western Australia (AU); Peter Duxson, Kwinana, Western Australia (AU)

(21) Appl. No.: 18/870,603

(22) PCT Filed: May 12, 2023
(86) PCT No.: PCT/AU2023/050404

§ 371 Date: Nov. 29, 2024

(30) Foreign Application Priority Data
May 12, 2022 (AU) 2022901272

(51) Int. Cl. B22F 1/145; C22B 34/12; C23C 22/02

(52) U.S. Cl. CPC B22F 1/145; C22B 34/1272; C23C 22/02; B22F 2301/205

(57) ABSTRACT

A process for producing a Ti or Ti alloy product includes exposing particles of pyrophoric Ti metal and Ti alloys to a liquor, gas or vapour that includes a passivation component that forms a passivated protective layer with Ti on surfaces of the particles.

### TECHNICAL FIELD

The present invention relates to pyrophoric materials that are metals and metal alloys.

Pyrophoric metals and metal alloys of particular interest to the applicant are titanium (“hereinafter referred to as “Ti”) metal and Ti alloys.

The present invention relates particularly to the production of particles of Ti metal and Ti alloys, such as Ti—Al—V alloys, that are:
(a) non-pyrophoric as measured by industry and customer standards, as described herein; and
(b) high purity, with very low concentrations of contaminants.

The present invention relates particularly to the production of particles of high purity Ti metals and Ti alloys, that are suitable for use in a wide range of industries, such as but not limited to the additive manufacturing and powder metallurgical industries and can be transported and/or processed safely.

### BACKGROUND

The applicant is developing technology to produce Ti metal and Ti alloys that are suitable for use in a wide range of applications, including membranes for use in electrolysis and the additive manufacturing industry.

The term “additive manufacturing” is understood herein to mean “an industrial production name for 3D printing, a computer-controlled process that creates three dimensional objects by depositing materials, usually in layers”.

The applicant's technology is described and claimed in a number of patent families, including but not limited to patent families based on International Publication Nos. WO 2017/027915, WO 2017/027915 and WO 2017/027914. The disclosures in the patent specifications of these PCT applications are incorporated herein by cross-reference.

One of the metals of particular interest to the applicant is Ti.

One of the Ti alloys of interest to the applicant is a Ti—Al—V alloy known as Ti64 alloy, Ti-6Al-4V.

Ti64 alloy generally refers to an alloy having a chemical composition of 6% aluminium, 4% vanadium, 0.25% (maximum) iron, 0.2% (maximum) oxygen, and the remainder Ti. Ti64 is also commonly referred to as Grade 5 Ti. Ti64 alloy is one of the most commonly used Ti alloys and is applied in a wide range of applications where low density and excellent corrosion resistance are necessary such as e.g., aerospace industry and biomechanical applications (implants and prostheses). Often, Ti64 alloy is formed into components for the applications by the use of additive manufacturing.

The applicant's technology described in WO 2017/027915, WO 2017/027915 and WO 2017/027914 and in specifications in other patent families includes a process for producing Ti metal that comprises:
(a) reducing TiCl₄ in a fluidised bed reactor with a Mg reductant and producing fine Ti metal particles dispersed in a protective MgCl₂ matrix, and
(b) removing the protective matrix in a vacuum distillation unit and producing an output of coalesced particles of Ti metal (or a Ti alloy in situations where other metals such as Al and V are formed in the fluidised bed reactor).

The applicant's technology is able to produce high purity particles of Ti metal and high purity particles of Ti alloys, such as Ti64.

An important pre-condition for a number of (although not necessarily all) industries that need Ti metal and Ti alloys, such as the additive manufacturing industry, is that feed Ti metal and Ti alloys have a very high purity.

For example, Ti64 alloy components made by additive manufacturing require high levels of purity of Ti64 alloy.

Low levels of contaminants in Ti metals and Ti64 alloy materials for additive manufacturing are important.

In the context of the applicant's technology described in International applications WO 2017/027915, WO 2017/027915 and WO 2017/027914 and other patent families, a relevant contaminant from the perspective of additive manufacturing is MgCl₂. Typically, it is important that the MgCl₂ concentration be less than 100 ppm, typically less than 50 ppm for additive manufacturing.

A further consideration is that, while overall measures of purity of Ti metal and Ti alloy materials for additive manufacturing need to be met, it is not acceptable to have impurities concentrated in the Ti metal and Ti alloys, such as the presence of significantly contaminated particles (elevated oxygen, interstitial and residual element composition).

Another important consideration for supplying Ti metals and Ti alloys and other feed metals and metal alloys to industries, such as the electrolysis (membranes) and the additive manufacturing industries, is the need to be able transport the Ti and Ti alloys from a manufacturing site to an end-use location safely and efficiently, be able to be handled preferably in air without deterioration of quality or material risk of burning, noting that metals such as Ti are reactive, can oxidise readily and are typically pyrophoric in an as-manufactured form. On this basis, these pyrophoric Ti and Ti alloys are highly dangerous when exposed to air and react readily with even very small concentrations of oxygen.

There are industry standards for what constitutes a pyrophoric material. To put this into context, every Ti metal powder will be somewhat pyrophoric when it is made. Therefore, invariably, producers have to treat, such as passivate a surface of, their pyrophoric material before selling it.

There are also customer standards that are more onerous than industry standards.

These industry and customer standards are based, for example, on the free and combined oxygen concentrations in the materials.

Typically, pyrophoric materials for many industries, including the electrolysis (membranes) and the additive manufacturing industries, are in the form of particles, particularly small particles (which may also be described as “powders”). The term “particles” is used herein interchangeably with “powders”.

Generally, small porous particles of a pyrophoric material are highly pyrophoric due to a high internal and external surface area of the particles that can react with oxygen.

These pyrophoric particles can undergo spontaneous combustion in the presence of air during transportation to and/or storage at an end-use location.

For conventional Ti metal and Ti alloy particles, such as Ti64 particles, of approximately <10 μm, pyrophoricity becomes a major issue, but can be serious even at much larger sizes (>100 μm) under some conditions.

The pyrophoric characteristics of Ti metal and Ti alloys are a significant barrier to commercialisation of Ti and Ti alloys in particulate form.

By way of context, a batch of a Ti metal or a Ti alloy that contains one pyrophoric particle can be set off, with a result that the whole batch burns. The pyrophoric particle can also not generate enough heat or be reactive enough to propagate through the batch. But the presence of one pyrophoric particle can be enough for a customer to downgrade the batch, with a loss of economic value for the supplier. Or some burning pyrophoric particles may not set off the remainder and it is therefore not “a pyrophoric powder”—it just sparkles a bit. It is a batch that is classified by customers, not individual particles. Having said this, individual burned particles in a batch of Ti metal or alloy are still unacceptable from a quality perspective.

The applicant has developed technology that makes it possible to produce high purity pyrophoric Ti metal and Ti alloys in a form that can be processed to be non-pyrophoric, high purity materials and transported to an end-use location safely.

The above description is not an admission of the common general knowledge in Australia or elsewhere.

### SUMMARY OF THE INVENTION

The invention makes it possible to produce air-stable, i.e., non-pyrophoric, and high purity Ti metal and Ti alloy particles from particles of pyrophoric Ti metal and Ti alloys with no major chemical changes to at least a major part of the pyrophoric Ti metal and Ti alloys.

Typically, the required reactions to form non-pyrophoric particles happen very quickly, often immediately, upon contact and with very little heat evolved. Therefore, typically, highly-engineered, large reaction vessels are not required.

In this context, typically, the invention passivates a surface of the particles of a pyrophoric material to make the particles non-pyrophoric, as measured by industry and customer standards. The pyrophoric material could be any pyrophoric material.

The term “passivates” is understood herein to mean to deactivation of a surface of a particle of a pyrophoric material such that it does not readily react with the environment in which it is designed to be handled, i.e., does not chemically degrade or combust through shipment, handling and processing. Passivation does not imply chemical stability in all environments, rather it means stability with reference to the environment for which the material is engineered to be subjected.

The applicant has found that passivation of pyrophoric Ti metal and Ti alloys in accordance with the invention provides an opportunity to achieve transformative physical properties of the material, with these properties including flowability, an important property for a number of end use applications.

The applicant has also found that passivation of particles of pyrophoric Ti metal and Ti alloys in accordance with the invention provides an opportunity to selectively control the oxygen concentration of passivated pyrophoric Ti metal and Ti alloy particles. This is an important feature in terms of meeting customer product specifications.

The invention is not confined to producing air-stable, i.e., non-pyrophoric, Ti metal and Ti alloy particles from pyrophoric Ti metal and Ti alloy particles produced in the applicant's process described in International applications WO 2017/027915, WO 2017/027915 and WO 2017/027914 and other patent families.

For example, pyrophoric Ti metal and Ti alloy particles to be passivated could be produced via the so-called GE process, such as disclosed in Australian patent 2010333714.

The invention also provides an opportunity to produce air-stable, i.e., non-pyrophoric, particles of pyrophoric Ti metal and Ti alloy particles with low concentrations of contaminants.

In particular, the invention also makes it possible to reduce further the concentration of contaminants in particles of pyrophoric Ti metal and Ti alloys that already have high purity, i.e., a low concentration, of a contaminant.

In general terms, the term “contaminant” is understood herein to mean any element or compound in the pyrophoric Ti metal and Ti alloys that is regarded by an end-user of a metal product made from the pyrophoric Ti metal and Ti alloys as detracting from the suitability of the product for an end-use application.

In the context of the applicant's process described in International applications WO 2017/027915, WO 2017/027915 and WO 2017/027914 and other patent families, MgCl₂ and other metal halides are a contaminant.

Other processes for producing Ti metal and Ti alloys produce the same and, in some cases, other contaminants.

The invention also provides an opportunity to produce air-stable, i.e., non-pyrophoric, particles of Ti metal and Ti alloys that have a higher flowability than the particles of the pyrophoric Ti metal and Ti alloys from which they are formed. As noted above, flowability is an important property for a number of end use applications.

The invention is based on a realisation that the pyrophoric classification of particles of pyrophoric Ti metal and Ti alloys produced by the applicant's process described in International applications WO 2017/027915, WO 2017/027915 and WO 2017/027914 and other patent families can be at least substantially eliminated and the purity of particles of pyrophoric Ti metal and Ti alloys can be maintained or increased by a passivation step of exposing the particles to a liquor, gas, or a vapour, that contains a passivation component that forms a protective passivation layer with Ti on a surface of the particles.

In particular, the applicant has found that the liquor, gas or vapour exposure step can:
(a) form a protective passivation layer, for example an oxide layer, on surfaces of the pyrophoric Ti metal and Ti alloy particles, and
(b) remove contaminants from the particles.

According to the present invention, there is provided a process for producing Ti metal and Ti alloys product comprising exposing particles of pyrophoric Ti metal and Ti alloys to a liquor, gas or vapour that contains a passivation component that forms a protective passivation layer with Ti on surfaces of the particles of the pyrophoric Ti metal and Ti alloys.

The passivation component in the liquor, gas or vapour may be one or more than one of oxygen, nitrogen and a hydrocarbon or any other element or compound that can form the protective passivation layer with Ti on surfaces of the particles of the pyrophoric Ti metal and Ti alloys.

The process may include selecting the passivation component and exposure conditions so that the exposure step does not add contaminants to the particles of passivated pyrophoric Ti metal and Ti alloys.

The applicant has found that passivation as a result of the process of the invention is particularly useful for higher surface area particles, such as those with an irregular surface and porosity and/or small size with a high surface area to volume ratio.

The particles may be spherical or non-spherical particles.

The particles may be any suitable size.

For example, the particles may be up to 500 μm, typically up to 350 μm, and more typically up to 250 μm.

One approach for defining non-spherical particles qualitatively and quantitatively is described as follows in a paper in the following link https://iopscience.iop.org/article/10.1088/1755-1315/1032/1/012014/pdf:
A particle's shape can be captured using three independent relative scales, Form, Roundness and Roughness.
The shape of a particle can be described using terms such as cubical, spherical, elliptical, elongated, flat, tubular, platy, lathlike, and needle. The form can be quantified using the length ratios of the three orthogonal axes. Barrett (1980) provides a list of at least 15 parameters that can be defined using these ratios. The aspect ratio is the ratio of the long axis L to the intermediate axis B. It is also known as the elongation. The ratio of the intermediate, B, and short axes is another term for flatness. Two more mathematical descriptors of the form are sphericity and eccentricity. Sphericity is defined as the ratio of particle volume to circumscribing sphere volume. The ratio of the particle's surface area to the surface area of an equal volume sphere is an alternative definition of sphericity.
The radius of curvature of each corner is averaged and compared to the radius of the particle Wadell's maximum inscribed circle to determine roundness. The procedure is two-dimensional, but it can be made three-dimensional by replacing circles with spheres.
Scale considerations are critical in the characterization of particle roughness. Because all surfaces are rough at some scale, roughness must be characterized at the scale deemed relevant to the problem at hand.

Typically, the process includes controlling the exposure step so that particles have a controlled increase in oxygen concentration in the exposure step.

The amount of the uplift (i.e., increase) in oxygen of particles will change based on the surface areas of particles. This means that both size and morphology of particles are important factors to take into account in the context of the exposure step.

Generally, the increase in oxygen uplift of particles in the exposure step is proportional to the surface areas of particles.

The process may include controlling the exposure step so that the oxygen concentration of particles of non-spherical particles of up to 250 μm that have the passivation layer have an increased concentration of oxygen of at least 100 ppm, more typically 200 ppm, and more typically 400 ppm over the oxygen concentration of non-spherical particles of pyrophoric Ti metal and Ti alloys that do not have the passivation layer.

The process may include controlling the exposure step so that the oxygen concentration of particles of spherical particles of up to 250 μm that have the passivation layer have an increased concentration of oxygen of at least 100 ppm over the oxygen concentration of spherical particles of pyrophoric Ti metal and Ti alloys that do not have the passivation layer.

Physical and mechanical properties of Ti metal change significantly with small changes of oxygen (100's to 1000's ppm). For this reason, standard specifications and customer requirements have formed around products with controlled levels of oxygen to achieve reproducible and reliable mechanical properties. The ability to control the oxygen content of particles of Ti metal and Ti alloys within the ranges of relevant customer requirements and industry standards after they have been formed is therefore highly valuable.

Typically, the process includes controlling the exposure step so that the oxygen concentration of particles that have the passivation layer is less than 4000 ppm, typically less than 3000 ppm, more typically less than 2000 ppm, even more typically less than 1800 ppm and yet even more typically less than 1500 ppm.

Typically, the process includes controlling the exposure step and controlling total oxygen in particles of pyrophoric Ti metal and Ti alloys that have the passivation layer to suit different customer requirements for oxygen.

The control may be achieved, by way of example, by adjusting the contact time of the liquor, gas, or vapour with particles of pyrophoric Ti metal and Ti alloys or by selection of a specific liquor, gas, or vapour.

The passivation layer may be a separate layer on an existing surface of particles of the pyrophoric Ti metal and Ti alloys.

Alternatively, the passivation layer may be a result of reactions between the passivation component and pyrophoric Ti metal and Ti alloys.

It is not essential to the invention that the passivation layer cover 100% of the surface area of the particles of pyrophoric Ti metal and Ti alloys. The passivation layer may cover any proportion of the surface area to change the pyrophoricity of Ti metal and Ti alloys from being classified as a Class 4.2 Dangerous Good to become a Class 4.1 Dangerous Good or an unclassified Good, for example to comply with industry and customer standards for transportation of the metal product.

By way of context, the invention makes it possible to treat particles of pyrophoric Ti metal and Ti alloys that have a high surface area to mass ratio which would otherwise spontaneously combust when exposed to air so that the treated particles can be exposed to air safely for a required time period, with the treatment not impacting adversely on product quality (for example by not forming C or H-containing contaminants).

The invention makes it possible to passivate particles of pyrophoric Ti metal and Ti alloys with a short contact period of time, typically in a few seconds or less for the lowest oxygen content.

The process may include selecting the contact time for increased oxygen transfer. Typically, contact times can be less than 2 hours, more typically less than 1 hour, and more typically less than 30 minutes.

The protective passivation layer may be classified as being a layer of a non-pyrophoric material.

The protective passivation layer may be an oxide.

The protective passivation layer may have a different chemical composition and is not confined to oxides.

The exposure step may remove at least a part of a contaminant from the particles of the pyrophoric Ti metal and Ti alloys so that the product is a purer metal product.

For example, when the particles of pyrophoric Ti metal and Ti alloys are made by the applicant's process described in WO 2017/027915, WO 2017/027915 and WO 2017/027914 and other patent families, the contaminant may include a metal halide.

The metal halide may be MgCl₂.

By way of example, the MgCl₂ concentration in particles of pyrophoric Ti metal and Ti alloys may be less than 300 ppm, typically less than 200 ppm, more typically less than 100 ppm.

The contaminant may include other contaminants in addition to a metal halide.

In some instances, the contaminant may include one or more metal halides.

The metal halide may be selected from a group consisting of MgCl₂, NaCl, KCl, LiCl, BaCl₂, CaCl₂, AlCl₃, TiCl₃, TiCl₂, and BeCl₂.

In a situation where the contaminant is MgCl₂, typically, the purer metal product has a MgCl₂ concentration of less than 100 ppm, typically less than 50 ppm, and more typically less than 20 ppm.

The liquor, gas or vapour may be in any suitable form.

The selection of the liquor, gas, or vapour for the exposure step in any given situation may be governed by a number of factors including, for example, any one or more of the following factors:
temperature,
contact time,
contact pressure,
particle morphology
particle surface chemistry, and
particle pore structure.

Different components may passivate a given pyrophoric material to different extents.

Different components may remove halides such as MgCl₂. For examples, some alcohols may be effective solvents to remove metal halides by forming stable salts. These stable salts may be removed by rinsing the particles in water.

Under ambient conditions, the pores of particles of a pyrophoric Ti metal and Ti alloy may be too small for a particular solvent to penetrate the desired pores. In that event, one option may be to apply pressure to facilitate penetration.

One option is to provide a closed bath of the liquor and particles of a pyrophoric Ti metal and Ti alloy and inject an inert gas such as argon into a head space of the bath to pressurise the bath.

The liquor may be a solution.

The liquor may be selected from any one or more than one of:
water,
alcohols, such as ethanol or methanol,
ethers,
ketones,
aliphatic hydrocarbons, such as n-pentane,
nitriles, such as acetonitrile,
furans, and
esters.

It is noted that the above liquors include the components oxygen, nitrogen and a hydrocarbon as part of the liquors.

The alcohol may be ethanol, including up to 5% denatured ethanol, or methanol.

The liquor may have its solvation potential for a given contaminant manipulated through formulation. For example, the AlCl₃ in THF/reverse Schlenk manipulation.

The ketone may be methyl isobutyl ketone (MIBK).

The ether may include heterocyclic ether C₄H₈O (THF).

The vapour may be a vapour phase of any one or more than one of the above-mentioned liquors.

The vapour may be any other suitable vapour phase.

The process may include exposing particles of pyrophoric Ti metal and Ti alloys to the liquor in an agitated vessel.

The particles of the Ti metal and Ti alloys may be agitated in a vessel to promote contact of the liquor and the particles.

The process may include exposing particles of pyrophoric Ti metal and Ti alloys to the liquor under pressure conditions.

The pressure may be any suitable pressure.

By way of example, the pressure may be less than 10 bar, noting that the actual pressure required in any given situation will be readily determined having regard to pore size, solvent and required pyrophoricity and/or product purity.

The process may include exposing particles of pyrophoric Ti metal and Ti alloys to the liquor at any suitable temperature. The applicant has conducted successful test work under ambient and elevated temperatures.

The contact, which may be the result of movement of the liquor into and out of the particles, may facilitate solvating and removing contaminants from the particles.

The process may include agitating pyrophoric Ti metal and Ti alloy particles and the liquor via mechanical, ultrasonic or other means to promote contact of the liquor with the particles, for example via movement of the liquor into and out of the particles.

The process may include rinsing the particles for example to remove any contaminants.

The process may include a rinse step after the exposure step.

The process may include multiple exposure and rinse steps.

The process may include drying the particles after discharging the particles from the exposure step.

The process may be operated at room temperature.

The process may be a batch or a continuous process.

The process may include treating, for example in a vacuum distillation unit, a composite material that includes particles of pyrophoric Ti metal and Ti alloys dispersed in a protective metal halide matrix and producing an intermediate pyrophoric feed material and milling the intermediate feed material and forming particles of the pyrophoric Ti metal and Ti alloys material for the above-described process.

The composite material treatment process may be as described in applicant's WO 2017/027915, WO 2017/027915, WO 2017/027914 and other patent families.

More particularly, the composite material treatment process may be as described in applicant's International applications WO 2017/027915, WO 2017/027915 and WO 2017/027914 and other patent families, comprising the following steps when the metal is Ti:
(a) reducing TiCl₄ in a fluidised bed reactor with a Mg reductant and producing Ti metal particles dispersed in a protective MgCl₂ matrix, and
(b) removing the protective matrix in a vacuum distillation unit and producing particles of Ti metal (or a Ti alloy in situations where other metals such as Al and V are formed in the fluidised bed reactor) that form particles of the pyrophoric material for the above-described process.

The composite material treatment process may be any other suitable process that can form particles of pyrophoric Ti metal or Ti alloys for the above-described process.

The composite material treatment process may comprise milling the particles of the pyrophoric Ti metal and Ti alloys from step (b).

According to the present invention there is also provided a process for producing a Ti metal or a Ti alloy product comprising the following steps:
(a) reducing TiCl₄ in a fluidised bed reactor (“FBR”) with a Mg reductant and producing Ti metal particles dispersed in a protective MgCl₂ matrix,
(b) removing the protective matrix in a vacuum distillation unit and producing particles, typically non-spherical particles, of Ti metal or a Ti alloy in situations where other metals such as Al and V are formed in the fluidised bed reactor; and
(c) exposing the particles of the pyrophoric Ti metal or Ti alloys to a liquor, gas or vapour that contains a passivation component that forms a protective passivation layer with Ti on surfaces of the particles.

The exposure step may reduce a chloride concentration in the particles of the pyrophoric Ti metal or Ti alloy.

The exposure step may reduce the chloride concentration in the particles of the pyrophoric Ti metal or Ti alloys by at least 20 ppm, typically 20-50 ppm, and more typically 25-35 ppm. The reduction can be in hundreds of ppm from the starting point—the key to the flow enhancement is that basically all chloride that can be practically removed by the exposure step has been removed. After the removable chloride is gone there may still be residual chloride, typically 120 ppm as an example, that cannot be taken away by the exposure step.

The applicant has found that (a) the irregular shape of particles of pyrophoric Ti metal or Ti alloy produced by the FBR and matrix removal steps above, or example in the applicant's process described in International applications WO 2017/027915, WO 2017/027915 and WO 2017/027914 and other patent families, and (b) subsequent exposure of those particles in the exposure step reduces the chloride concentration and increases the flowability of the particles compared to the flowability of the particles produced in the matrix removal step.

The applicant has also realised that the applicant's process can be operated to produce particles of a pyrophoric Ti metal or Ti alloys that have a suitable porosity and a density range for a number of end-use applications and the treatment process of the invention does not have an impact on these properties.

For example, the applicant has found that the combination of porosity and density make it possible to compress air-stable, i.e., non-pyrophoric, particles of pyrophoric Ti metal or Ti alloys uniaxially to form a sheet. This capacity for compaction is important in many end-use applications.

The process may include milling particles produced in the matrix removal step before carrying out the exposure step.

The process may include a rinse step after the exposure step.

The process may include multiple liquor contact and rinse steps.

According to the present invention there is also provided an apparatus for producing a Ti metal and Ti alloy product that comprises a contact unit that is configured to bring into contact particles of pyrophoric Ti metal and Ti alloys and a liquor, gas or vapour that includes a passivation component that can form a protective passivation layer on surfaces of the particles of the pyrophoric Ti metal and Ti alloys.

The contact unit may include a vessel for the particles of pyrophoric Ti metal and Ti alloys and the liquor and an agitator or mixing the particles and the liquor.

The contact unit may include a separator or separating the particles and the liquor.

The apparatus may include any suitable unit or units for forming particles of the pyrophoric Ti metal and Ti alloys.

By way of example, the apparatus may be as may be as described in applicant's International applications WO 2017/027915, WO 2017/027915 and WO 2017/027914 and other patent families and include:
(a) a unit, such as a fluidised bed reactor, for producing a composite material that includes particles of pyrophoric Ti metal and Ti alloys dispersed in a protective metal halide matrix;
(b) a unit for producing an intermediate pyrophoric Ti metal or Ti alloys from the composite material; and
(c) a unit for milling the intermediate feed material and forming particles of pyrophoric Ti metal or Ti alloys.

The above-described units may be any suitable units.

The unit for producing the intermediate pyrophoric material may be a vacuum distillation unit.

According to the present invention there is also provided an apparatus for producing a non-pyrophoric Ti metal and Ti alloy product that includes:
(a) a fluidised bed reactor for forming a composite material that includes pyrophoric Ti metal and Ti alloy particles dispersed in a protective metal halide matrix;
(b) a continuous vacuum distillation unit (“CVDU”) for treating the composite material to remove the metal halide by vacuum distillation and form an intermediate pyrophoric Ti metal or Ti alloy;
(c) a mill for milling the intermediate pyrophoric Ti metal or Ti alloy to a required particle size distribution and forming milled particles of the pyrophoric Ti metal or Ti alloy; and
(d) a vessel for contacting the milled particles of the pyrophoric Ti metal or Ti alloy and a liquor, gas or vapour to form a protective passivation layer on surfaces of the particles of the pyrophoric Ti metal and Ti alloy and thereby form the Ti metal and Ti alloy product.

### BRIEF DESCRIPTION OF THE DRAWING

The invention is described further hereinafter with reference to the following Figures, of which:

FIG. 1 is a flow chart of an embodiment of a process and an apparatus for producing Ti metal and Ti alloy products in accordance with the invention;

FIG. 2 is a graph of oxygen analysis of samples of pyrophoric Ti metal particles passivated with methanol and THF under different conditions in test work carried by the applicant;

FIGS. 3 and 4 are graphs of oxygen uplift and chloride concentrations, respectively, for samples of pyrophoric Ti metal particles passivated with ethanol under different conditions in test work carried by the applicant;

FIGS. 5 and 6 are graphs of oxygen uplift and chloride concentrations, respectively, for samples of pyrophoric Ti metal particles passivated with THF under different conditions in test work carried by the applicant;

FIGS. 7 and 8 are graphs of oxygen uplift and chloride concentrations, respectively, for samples of pyrophoric Ti metal particles passivated with methanol under different conditions in test work carried by the applicant;

FIGS. 9 and 10 are graphs of oxygen uplift and chloride concentrations, respectively, for samples of pyrophoric Ti metal particles passivated with water under different conditions in test work carried by the applicant;

FIGS. 11 and 12 are graphs of oxygen uplift and chloride concentrations, respectively, for samples of pyrophoric Ti metal particles passivated with dimethoxyethane (“DME”) under different conditions in test work carried by the applicant;

FIG. 13 is a graph of oxygen uplift for samples of pyrophoric Ti metal particles passivated with n-pentane under different conditions in test work carried by the applicant; and

FIG. 14 is a graph of oxygen uplift for samples of pyrophoric Ti metal particles passivated with acetonitrile under different conditions in test work carried by the applicant.

### DESCRIPTION OF EMBODIMENTS

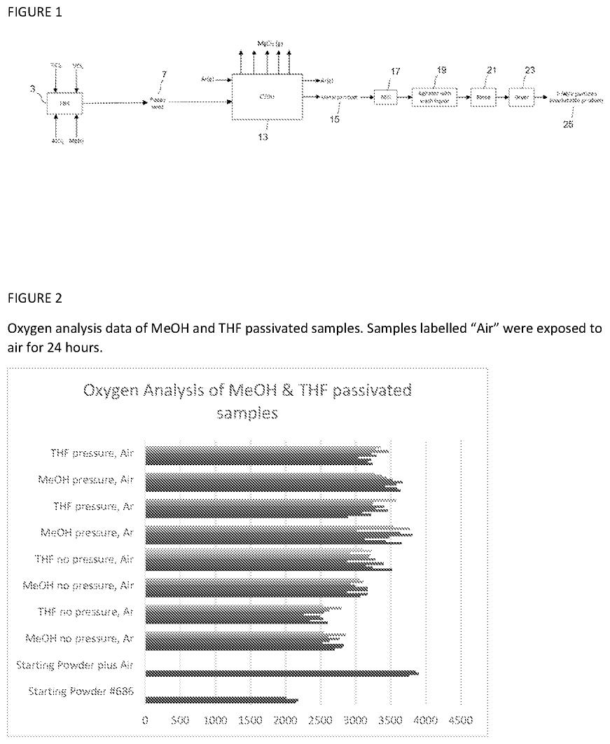

The embodiment of the invention shown in FIG. 1 produces an air stable Ti metal and Ti alloy products with low concentrations of contaminants from pyrophoric Ti metal and Ti alloys, with no major chemical changes to the Ti metal and Ti alloys.

As noted above, the invention is based on a realisation that the pyrophoricity of pyrophoric Ti metal and Ti alloy particles produced by the applicant's process described in WO 2017/027915, WO 2017/027915 and WO 2017/027914 and other patent families can be decreased and the purity of Ti metal and Ti metal alloy particles can be maintained or increased by a passivation step of contacting the particles with a suitable liquor, gas, or vapour that contains a passivation component.

In particular, the applicant has found that a liquor contact step or a gas contact step a vapour contact step can:
(a) form a protective oxide layer on surfaces of pyrophoric Ti metal and Ti alloy particles; and/or
(b) remove contaminants from these particles.

In one embodiment of the present invention shown in FIG. 1, the process includes contacting Mg with TiCl₄, AlCl₃ and VCl₄ in a fluidised bed reactor (FBR) 3 and forming a composite material 7 containing Ti—Al—V (Ti64) particles dispersed in a MgCl₂ matrix—also known as poppy seed. Typically, the MgCl₂ is at least 90% by volume of the poppy seed 7. The composite poppy seed 7 is discharged from the FBR 3. The poppy seed 7 is transferred to and treated in a continuous vacuum distillation unit (CVDU) 13 to remove MgCl₂ by vacuum distillation. The vacuum distillation results in the poppy seed forming a coalesced mass of particles, metal product 15. The resultant metal product 15 containing Ti64 particles is discharged from the CVDU and is milled in a mill 17 to a desired particle size. The milled particles are mixed with a suitable liquor such as ethanol in a liquor exposure step in an agitated vessel 19. This liquor contact step forms a protective passivation layer on surfaces of the particles and at least substantially removes residual MgCl₂ from the Ti64 particles. The resultant slurry produced in the liquor contact step is discharged from the agitated vessel, rinsed 21, and dried in a dryer 23 to form Ti64 particles.

The liquor contact step facilitates a passivation layer forming on the surfaces of the Ti64 particles which protects the Ti64 particles from oxidation. Specifically, ethanol passivates the surfaces of the Ti64 particles discharged from the CVDU.

The liquor contact step provides a higher level of purity of the Ti64 particles than the purity achieved with the CVDU on its own. Specifically, ethanol removes residual MgCl₂ from the Ti64 particles discharged from the CVDU.

The above-described embodiment can be adapted to produce passivated particles of pyrophoric Ti metal and passivated particles of other pyrophoric Ti alloys.

For example, another embodiment of the invention that is substantially the same as that described in relation to FIG. 1 operates with Mg and TiCl₄, in the FBR 3 and produces Ti metal particles.

One embodiment of a liquor contact step for passivating pyrophoric Ti metal particles includes a plurality, typically at least 2, more typically 2-6, successive liquor contact steps in a vessel, with ethanol (or other suitable liquor), and with the vessel having a ribbon blender (or other suitable agitator) for mixing −63 μm particles of pyrophoric Ti metal.

The vessel may be any suitable construction and size.

The set-up for the embodiment includes:
(a) Ethanol:Ti ratio in a range of 1 L:1 kg—5 L:1 kg
(b) Operating with a slight argon pressure in the vessel, and therefore keeping a bleed valve open.

The liquor contact step of the embodiment includes the following steps:
1. Fill vessel with pyrophoric Ti particles.
2. Supply ethanol under argon gas to the vessel.
3. Turn on ribbon blender in the vessel and mix the particles and ethanol for a selected period of time under argon.
4. Stop the blender and let the particles settle for before decanting ethanol down to the particle level in the vessel.
5. Repeat steps 1-4 for a selected number of times to complete passivation of the particles.
6. Leave the last wash inside the vessel for at least 8 hours.
7. After the last wash, transfer the slurry of passivated Ti metal particles and ethanol to a drying unit configured to allow ethanol to drain from the now-passivated particles and be removed from the unit before drying the particles in the unit.
8. Dry the passivated Ti metal particles under vacuum in the drying unit for a nominated time period.

### Test Work

The applicant has carried out extensive test work with a number of different liquors, including liquors selected from water, alcohols (methanol and ethanol), ethers, ketones, furans, nitriles, aliphatic hydrocarbons, and esters.

The applicant has found in the extensive test work that is possible to produce Ti metal or Ti alloy products comprising Ti metal or Ti alloy particles that are passivated, i.e., non-pyrophoric, to the extent that the products comply with industry and customer standards for safe transportation and have concentrations of residual chloride that meet customer requirements for end-use applications.

A selection of the extensive test work is described below.

### Water and Alcohol Passivation Test Work Development

The applicant conducted a series of successful phased passivation trials with Ti metal particles (which can be described as powders) in water and alcohol.

The phased trials found a dramatic reduction in reactivity ofTi.

Ti metal particles produced in accordance with the applicant's technology described in WO 2017/027915, WO 2017/027915, and WO 2017/027914 and in specifications in other patent families are pyrophoric, and as described above, there is a need to safely passivate while ensuring that the oxygen concentration in the powder to <3500 ppm, which ensures the product remains commercially relevant and within Ti industry product specifications.

Water, ethanol and methanol were selected as passivation liquors for the test work.

The applicant initially carried out the following phased trials on a laboratory scale. Ti metal particle samples were mixed with water, ethanol and methanol and the response of the samples to exposure to these liquors was assessed by measuring temperature rises in the passivation liquor. Temperature rises were taken as indications of reactions of Ti metal samples.

Table 1 provides a summary of the results of the phased trials.

TABLE 1
Description of phased trials - Ti particles passivation.

| | Trial | Justification | |
|---|---|---|---|
| Phase 1 | Laboratory | Literature precedents for Ti stability in water - see | |
| | | Corrosion Resistance of Ti, Ti Metals Corporation, 1997 | |
| Phase 2 | Water - small scale | Laboratory trials | |
| | 10 L, 3 trials. | | |
| Phase 3 | Water - medium scale | Evidence to move to phase 3 was minimal temperature | |
| | 150 L, 1 trial. | rise in water passivation experiments. Negligible | |
| | | reaction of Ti powder with water. Equipment design | |
| | | was determined satisfactory with 3 water-based trials. | |
| Phase 4 | Ethanol - small scale | 1. | Transition to Phase 4 - water passivation was |
| | 15 L, 17 trials. | | scaled to 150 L safely, but the resultant |
| | | | passivated Ti was not a commercially relevant |
| | | | material (6000 ppm oxygen content). |
| | | 2. | Laboratory experiments in ethanol showed no |
| | | | temperature rise or visible reaction and |
| | | | resultant Ti powder exhibited oxygen that met |
| | | | industry specifications. |

| | | |
|---|---|---|
| Phase 5 | Ethanol - medium scale | Transition to Phase 5 - temperature rise <2° C. over 17 |
| | 100 L in 200 L drum | ethanol trials. |
| Phase 6 | Ethanol - medium scale, | Transition to Phase 6 - similar scale, same solvent, |
| | vessel change, 150 L. | vessel change to a ribbon blender. |
| | 6 trials. | |
| Phase 7 | Methanol - medium | Transition to Phase 7 - Laboratory trials were |
| | scale, same vessel as | performed in methanol - no temperature rise. |
| | Phase 6, 150 L. | |

The phased trials 1-5 (Table 2) were carried out using the following equipment set-up:
A stainless-steel bucket (20 L) was chosen as the vessel as it could contain the passivation liquor, argon flow in and out of the vessel was viable, and the vessel could facilitate Ti metal particles being fed in at a relatively small scale (2-5 kg). A stainless-steel lid was welded with the required fittings to allow for these engineering controls.
A manifold was constructed to precisely control the argon flow and measure the oxygen content of the system. Oxygen levels were <7 ppm for all trials.

It was evident from the phased trials that there was effective passivation with methanol and ethanol.

### Further Passivation Test Work (1)

Further test work was carried out by the applicant:
(a) to understand the change in oxygen and chlorine levels of pyrophoric Ti metal particles (which can be described as being in a powder form) when subject to passivation with different liquids under ambient and pressure conditions; and
(b) compared the performance (passivation and contaminant removal (chloride)) of ethanol and a cyclic-ether (“THF”).

Exposure of passivated pyrophoric Ti metal particles to air was also undertaken to measure oxygen uplift.

### Experimental Steps

Argon-based Leco samples to determine oxygen and nitrogen concentrations of pyrophoric Ti metal particles (which can also be described as “powders”) were prepared.
Leco analysis was performed on the samples.
Air exposure of passivated Ti metal particles was conducted.
Air-based Leco sample preparation and analysis was performed.

### General Experimental Conditions

All tests were performed in an argon gas glovebox (GB) unless otherwise specified.

The pyrophoric Ti metal particles tested were produced in accordance with the applicant's technology described in WO 2017/027915, WO 2017/027915, and WO 2017/027914 and in specifications in other patent families.

Methanol was obtained from the applicant's production plant in Kwinana and used without further purification.

Tetrahydrofuran (“THF”) (Merck, anhydrous) was purchased from Rowe Scientific, was strictly stored in an argon glovebox, and was used without further purification.

The glovebox atmosphere was <10 ppm O₂ during all experiments.

### Passivation Experiments

Pyrophoric Ti metal particles (6.0 g) was placed into steel vials (50 mL).
Liquid (10 mL) containing a passivation component was added to the vessel.
The mixture was subjected to magnetic stirring for 10 minutes, followed by decanting of liquid.
This was repeated 3 times (Table 1) for a total of 3 washes.

TABLE 3
Methanol and THF exposure conditions
for a 1^{st} wash, repeated 3 times

| | MeOH | THF |
|---|---|---|
| Wash 1 Volume (mL) | 10 | 10 |
| Wash 1 temp (° C.) | 36 | 36 |
| Wash 1 time (mins) | 10 | 10 |
| Wash 1 agitation | Mag. Stir | Mag. Stir |

After the third liquid wash and decanting, the slurry of particles and liquor was split into 2 parts, namely:
A (atmosphere) samples.
P (pressure) samples.

A Samples are samples that were not subjected to pressure. The samples were dried under vacuum overnight in the glovebox and stored under argon.

P Samples are samples that were subjected to 12 barg argon pressure.

More liquor (10 mL) was added to these slurry samples P. The mixture was placed in a 4-inch diameter ANSI tube with a graphite seal and sealed with a rattle gun to a maximum torque.

The following experiments were conducted in the ANSI tube:
3× methanol wash
3× THF wash

The ANSI tube was then pressurized with 10 barg argon pressure for 13 hours at room temperature (starting temperature of 36° C., finishing temperature of 24° C.).

After depressurizing the tube, the samples were removed.

All A and P samples were further split into 2 groups based on the gas that they were exposed to:
B—exposure to argon gas only; and
Air—exposure to air for 24 hours.

In summary, the following samples were prepared and tested:
1. Liquor contact, no pressure, not air exposed.
2. Liquor contact, no pressure, air exposed.
3. Liquor contact, pressure, not air exposed.
4. Liquor contact, pressure, air exposed.
5. Base—no liquor, no pressure, air exposed

TABLE 4
Samples, codes and numbers created for the
methanol and THF passivation test work

| Liquor | Pressure | Exposure | Sample No. | Analysis |
|---|---|---|---|---|
| MeOH | A1 | B | 689 | 3x LECO |
| MeOH | A2 | B | 690 | 3x LECO |
| MeOH | A3 | B | 691 | 3x LECO |
| THF | A1 | B | 692 | 3x LECO |
| THF | A2 | B | 693 | 3x LECO |
| THF | A3 | B | 694 | 3x LECO |
| MeOH | A1 | Air | 695 | 3x LECO |
| MeOH | A2 | Air | 696 | 3x LECO |
| MeOH | A3 | Air | 697 | 3x LECO |
| THF | A1 | Air | 698 | 3x LECO |
| THF | A2 | Air | 699 | 3x LECO |
| THF | A3 | Air | 700 | 3x LECO |
| MeOH | P1 | B | 701 | 3x LECO |
| MeOH | P2 | B | 702 | 3x LECO |
| MeOH | P3 | B | 703 | 3x LECO |
| THF | P1 | B | 704 | 3x LECO |
| THF | P2 | B | 705 | 3x LECO |
| THF | P3 | B | 706 | 3x LECO |
| MeOH | P1 | Air | 707 | 3x LECO |
| MeOH | P2 | Air | 708 | 3x LECO |
| MeOH | P3 | Air | 709 | 3x LECO |
| THF | P1 | Air | 710 | 3x LECO |
| THF | P2 | Air | 711 | 3x LECO |
| THF | P3 | Air | 712 | 3x LECO |

“B” exposure samples in the above table were subjected to triplicate Leco preparation under argon gas.

As noted above, “A” exposure samples in the above table were exposed to air for 24 hours in a laboratory. After 24 hours they were transferred back into the glovebox for storage under argon and to maintain 24 hours air exposure. Upon Leco sample preparation, the air exposed samples were removed from the glovebox in small groups and Leco samples were prepared in the air.

Oxygen results of these samples are shown in FIG. 2.

FIG. 2 shows the oxygen concentrations for multiple samples for each category ((a) air exposed or argon gas exposed and (b) pressure or no pressure) for each liquor. Table 5 reports on the standard deviations for the samples.

TABLE 5
Oxygen average and standard deviation from FIG. 2 data

| | Starting | Starting | MeOH | THF | MeOH no | THF no | MeOH | THE | MeOH | THF |
|---|---|---|---|---|---|---|---|---|---|---|
| | Powder | Powder | ambient, | ambient, | pressure, | pressure, | pressure, | pressure, | pressure, | pressure, |
| | #686 | plus Air | Ar | Ar | Air | Air | Ar | Ar | Air | Air |
| AVERAGE O2 | 2116 | 3838 | 2700 | 2530 | 3058 | 3191 | 3497 | 3270 | 3501 | 3253 |
| Std Dev O2 | 91 | 67 | 12 | 157 | 112 | 187 | 271 | 203 | 134 | 122 |

Pyrophoric Ti metal particles were exposed to liquors at ambient conditions and maintained under argon, resulting in an oxygen concentration uplift, summarised below:

Liquor exposure at ambient/Ar, oxygen rise from pyrophoric Ti metal particles:
Methanol—600 ppm
THF—400 ppm

The ambient/Ar treated particles were subjected to the following conditions.

Exposed to air for 24 hours, oxygen rise from ambient/Ar:
Methanol—350 ppm
THF ˜650 ppm

Exposed to pressure/liquor, no air, oxygen rise from ambient/Ar:
Methanol—800 ppm
THF—750 ppm

Exposed to pressure/liquor, plus air exposure, oxygen rise from ambient/Ar:
Methanol—800 ppm
THF ˜750 ppm

The results show that oxygen uplift with liquor passivation is less than with air passivation.

In addition, there was less oxygen uplift with THF compared with methanol for ambient and pressure exposure of pyrophoric Ti metal particles.

### Further Passivation Test Work (2)

Additional passivation test work was carried out by the applicant to evaluate the passivation performance of water, ethanol, methanol, dimethoxyethane (“DME”), n-pentane, acetonitrile and cyclic-ether (“THF”).

Samples of pyrophoric Ti metal particles and the above liquors were prepared and tested in accordance with the procedure described in the preceding section:
1. Liquor contact, no pressure, not air exposure.
2. Liquor contact, no pressure, air exposure.
3. Liquor contact, pressure, not air exposure.
4. Liquor contact, pressure, air exposure.
5. Base—no liquor, no pressure, no air exposure

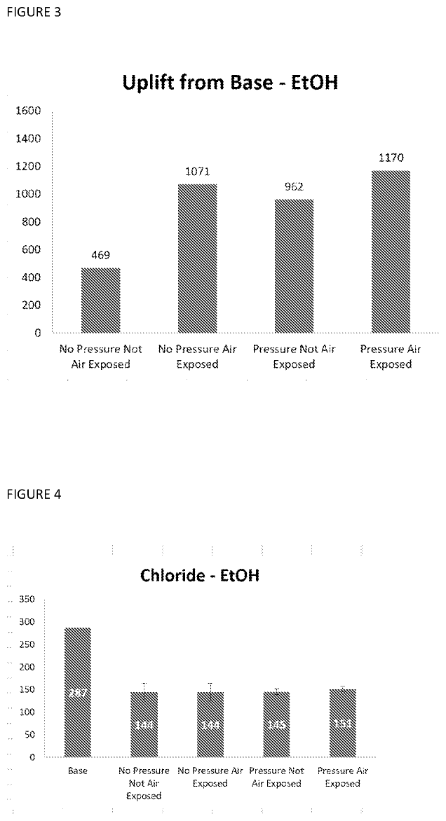

A selection of the results of the test work is summarised in FIGS. 3-14. The Figures report the following results for each liquor:
(a) oxygen uplift of test protocols 1-4 above compared to the base case 5 (i.e., no liquor, air exposed, and no pressure); and
(b) chloride uplift for test protocols 1-4 above and base case 5 (not for n-pentane and acetonitrile).

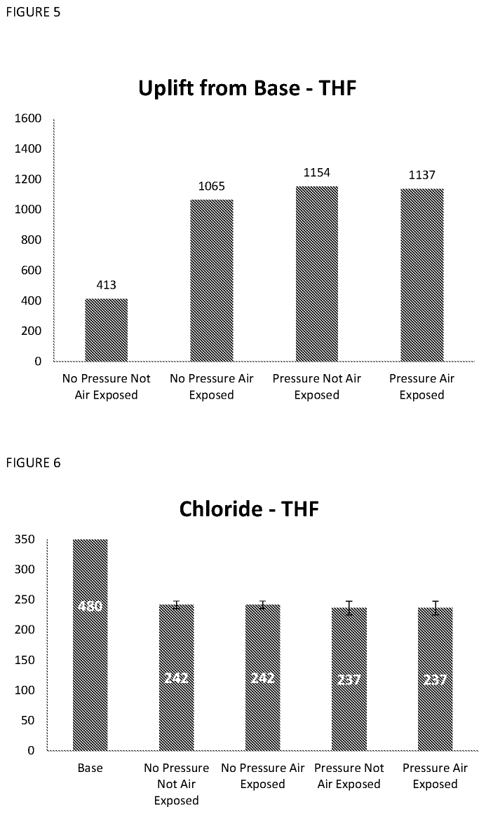

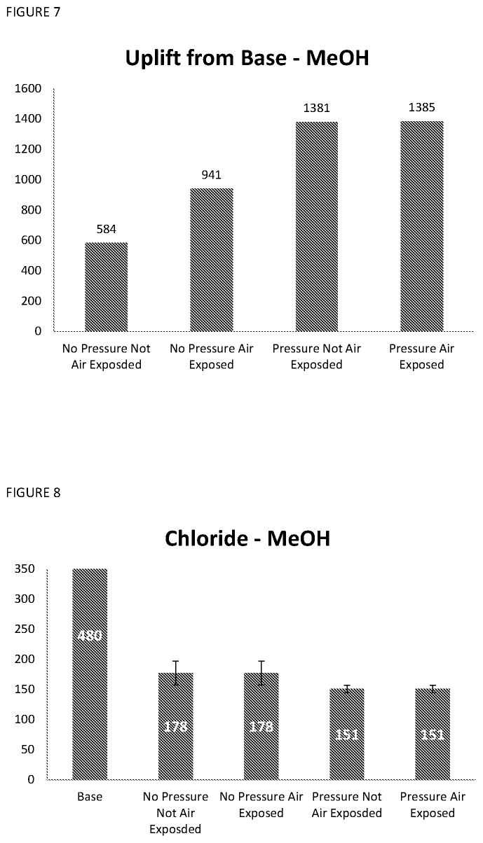

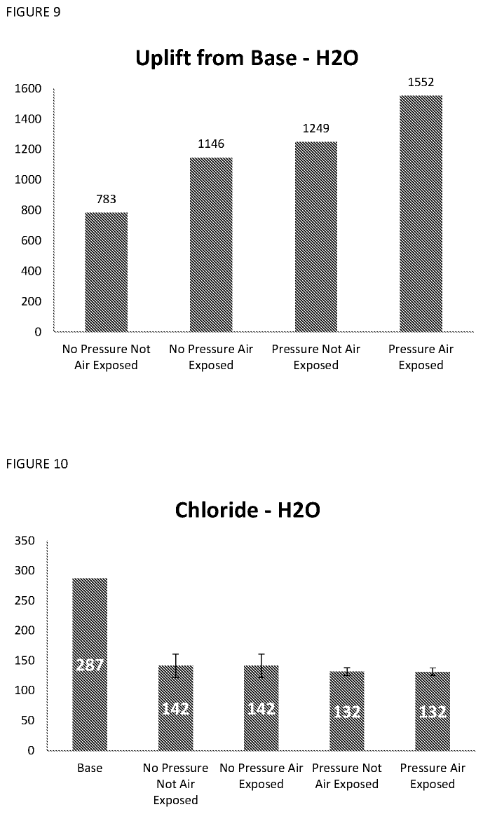

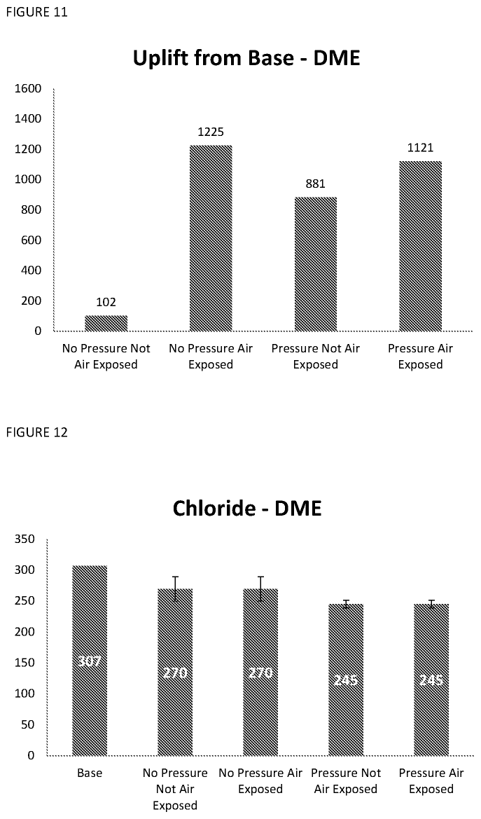

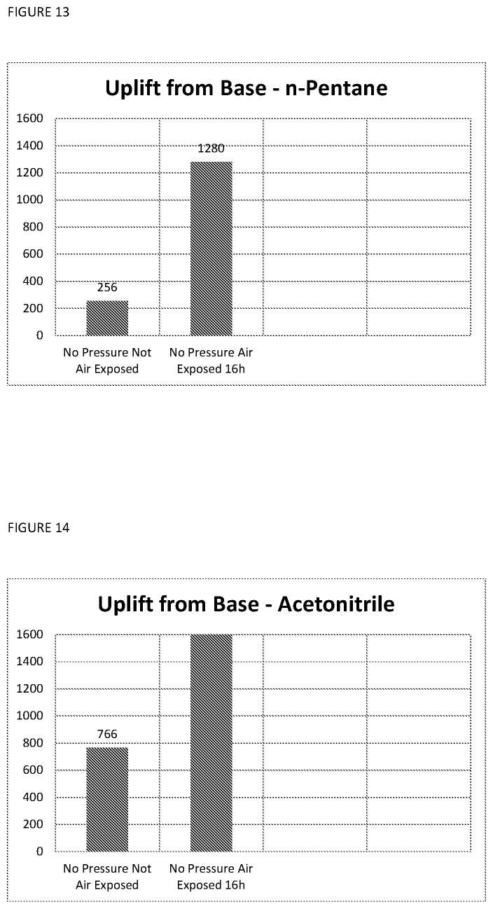

FIGS. 3 and 4 show the results for ethanol. FIGS. 5 and 6 show the results for THF. FIGS. 7 and 8 show the results for methanol. FIGS. 9 and 10 show the results for water. FIGS. 11 and 12 show the results for DME. FIG. 13 shows the results for oxygen uplift for n-pentane. FIG. 14 shows the results for oxygen uplift for acetonitrile.

Ethanol had one of the lowest oxygen uplifts from the base pyrophoric Ti metal particles −469 ppm oxygen uplift.

In addition, the ethanol results for chloride indicate that passivated Ti metal particles had one of the lowest chloride levels at 144 ppm.

THF had a lower oxygen uplift at 413 ppm than ethanol, but it results in passivated Ti metal particles with residual chloride levels at 242 ppm.

The oxygen uplifts with water and methanol are higher than for ethanol and methanol. The residual chloride levels are comparable to that for ethanol.

In all cases, the oxygen uplifts are within customer specifications known to the applicant.

The results also show that the extent of oxygen uplift can be controlled with liquor selection and exposure time. The exposure time point was evident from other results not reported here.

With regard to oxygen, as noted above, oxygen concentration in passivated pyrophoric Ti metal and Ti alloy particles is an important consideration.

Physical and mechanical properties of Ti metal change significantly with small changes of oxygen (100's to 1000's ppm). For this reason, standard specifications and customer requirements have formed around products with controlled levels of oxygen to achieve reproducible and reliable mechanical properties. The ability to control the oxygen content of particles of Ti metal and Ti alloys within the ranges of relevant customer requirements and industry standards after they have been formed is therefore highly valuable.

### Test Work Summary

In summary, the above test work shows that ethanol, methanol, water, THF, n-pentane, acetonitrile, and DME can effectively passivate pyrophoric Ti metal particles and reduce chloride levels in pyrophoric Ti metal particles. These are significant findings.

It is noted that test work was conducted by the applicant at elevated temperatures (as well as ambient temperatures for the above test work), and particles tested were successfully passivated.

In addition, the test work carried out by the applicant indicates that similar results can be obtained with pyrophoric Ti alloys, such as Ti64.

### General Comments

The applicant has carried out fundamental research work and the above-described and further test work.

Whilst not wishing to be bound by the following comments, the applicant believes that the observed passivation is due to passivation components of the liquors tested forming passivated protective layers with Ti on the surfaces of particles of pyrophoric Ti metal and Ti alloys.

In the case of the test work reported above, the passivation components are oxygen, nitrogen and hydrocarbons.

An important observation is that these passivation components and exposure conditions can be selected so that there is no significant contamination (for example by chlorides) of the passivated pyrophoric Ti metal and Ti alloy particles. This is important for many end-use applications.

Many modifications may be made to the embodiment described above in relation to FIG. 1 without departing from the spirit and scope of the invention.

By way of example, whilst FIG. 1 describes an embodiment of the process and apparatus of the invention that produces air-stable, passivated, i.e., non-pyrophoric, particles of a pyrophoric material with low concentrations of contaminants, the invention is not confined to reducing contaminant concentrations.

In other words, the invention includes embodiments that passivate particles of a pyrophoric material so that they become passivated, i.e., non-pyrophoric, as measured by industry and customer standards, with or without reducing the concentration of contaminants in the pyrophoric material.

In addition, whilst FIG. 1 describes an embodiment of the process and apparatus of the invention in the context of MgCl₂ as a contaminant, the invention is not confined to this contaminant.

In addition, whilst FIG. 1 describes an embodiment of the process and apparatus of the invention in the context of a liquor, the invention also extends to the use of suitable gases and vapours.

1. A process for producing a Ti or Ti alloy product including exposing particles of pyrophoric Ti metal and Ti alloys to a liquor, gas or vapour that includes a passivation component that forms a passivated protective layer with Ti on surfaces of the particles of pyrophoric Ti metal and Ti alloys.

2. The process defined in claim 1 wherein the passivation component is one or more than one of oxygen, nitrogen and a hydrocarbon.

3. (canceled)

4. The process defined in claim 1 including controlling the exposure step so that the oxygen concentration of particles of pyrophoric Ti metal and Ti alloys that are non-spherical particles of up to 250 μm have an increased concentration of oxygen of at least 100 ppm over the oxygen concentration of non-spherical particles of pyrophoric Ti metal and Ti alloys that do not have the passivation layer.

5. The process defined in claim 1 including controlling the exposure step so that the oxygen concentration of particles of pyrophoric Ti metal and Ti alloys that are of spherical particles of up to 250 μm that have the passivation layer have an increased concentration of oxygen of at least 100 ppm over the oxygen concentration of spherical particles of pyrophoric Ti metal and Ti alloys that do not have the passivation layer.

6. The process defined claim 1 including controlling the exposure step so that the oxygen concentration of particles that have the passivation layer is less than 4000 ppm.

7. The process defined in claim 1 wherein the passivation layer is a separate layer on an existing surface of the particles of pyrophoric Ti metal and Ti alloys.

8. The process defined in claim 1 wherein the passivation layer is a result of reactions between the passivation component and the pyrophoric Ti metal and Ti alloys.

9. (canceled)

10. The process defined in claim 1 wherein the passivation layer includes an oxide.

11. The process defined claim 1 wherein the exposure step includes removing at least a part of a contaminant from the particles of pyrophoric Ti metal and Ti alloys so that the metal product is a purer metal product, wherein the contaminant includes a metal halide including any one or more of MgCl₂, NaCl, KCl, LiCl, BaCl₂, CaCl₂, AlCl₃, TiCl₂, TiCl₃, and BeCl₂.

12-14. (canceled)

15. The process defined in claim 1 wherein the liquor is selected from any one or more than one of:
water,
alcohols, such as ethanol or methanol,
ethers,
ketones,
aliphatic hydrocarbons,
nitriles,
furans, and
esters.

16. The process defined in claim 1 includes exposing particles of pyrophoric Ti metal and Ti alloys to the liquor in an agitated vessel.

17. The process defined in claim 1 includes rinsing the particles to remove contaminants after the exposure step.

18. The process defined in claim 17 includes multiple exposure and rinse steps.

19. A process for producing a Ti metal or a Ti alloy product comprising the following steps:
(a) reducing TiCl₄ in a fluidised bed reactor (“FBR”) with a Mg reductant and producing Ti metal particles dispersed in a protective MgCl₂ matrix,
(b) removing the protective matrix in a vacuum distillation unit and producing particles of Ti metal or a Ti alloy in situations where other metals such as Al and V are formed in the fluidised bed reactor; and
(c) exposing the particles of the pyrophoric Ti metal or Ti alloys to a liquor, gas or vapour that contains a passivation component that forms a protective passivation layer with Ti on the surface of the particles.

20. The process defined in claim 19 wherein the exposure step reduces a chloride concentration in the particles of the pyrophoric Ti metal or Ti alloy.

21. The process defined in claim 19 wherein the exposure step reduces the chloride concentration in the particles of the pyrophoric Ti metal or Ti alloys by at least 20 ppm.

22. The process defined in claim 19 includes milling particles produced in the matrix removal step before carrying out the exposure step.

23. The process defined in claim 19 includes a rinse step after the exposure step.

24. (canceled)

25. An apparatus for producing a Ti metal and Ti alloy product that comprises a contact unit that is configured to bring into contact particles of pyrophoric Ti metal and Ti alloys and a liquor, gas or vapour that includes a passivation component that can form a protective passivation layer on surfaces of the particles of the pyrophoric Ti metal and Ti alloys.

26. The apparatus defined in claim 25 wherein the contact unit includes a vessel for the particles of pyrophoric Ti metal and Ti alloys and the liquor that contains the passivation component and an agitator for mixing the particles and the liquor.

27. (canceled)
